(19) United States
(12) Patent Application Publication
(10) Pub. No.: US 2003/0225592 A1
(43) Pub. Date: Dec. 4, 2003

(54) System and method for a business-to-consumer delivery network within a local district

(76) Inventors: Allan Stuart Algazi, Succasunna, NJ (US); Salvatore Anthony Sparacino, Smithtown, NY (US)

Correspondence Address: Fay Kaplun & Marcin LLP, 150 Broadway, Ste 702, New York, NY, 10038, US

(21) Appl. No.: 10/264,183

(22) Filed: Oct. 3, 2002

Related U.S. Application Data
(60) Provisional application No. 60/384,016, filed on May 29, 2002.

(51) Int. Cl. G06F 17/60

(52) U.S. Cl. 705/1; 705/401

(57) ABSTRACT

Described is a method and system for a business-to-consumer delivery network within a local district. A package is prepared for a delivery to a recipient. A label is placed on a package. The label includes data regarding a sender, a recipient and a package identification. The sender and recipient are located within a predetermined local geographical area. The package is provided to a messenger of a delivery service during a routine stop of the messenger. Then, the package is delivered to a local delivering center of the delivery service which services the predetermined geographical area. Subsequently, the package is registered and sorted using the label only at the delivering center. Finally, the package is delivered to the recipient by a further messenger of the delivery service during a routine stop of the further messenger.

### PRIORITY CLAIM

This application claims the benefit of U.S. Provisional Patent Application Serial No. 60/384,016 filed on May 29, 2002 and entitled “Blockbuster Test Material” and is expressly incorporated herein, in its entirety, by reference.

### FIELD OF THE INVENTION

The present invention relates to a system and method for a business-to-consumer delivery network within a particular geographical district (e.g., a particular district of the United States Post Office).

### BACKGROUND

Although consumers have been able to purchase goods remotely from retailers for many decades, delivery methods have evolved little even with the advent of the new technologies (e.g., Internet). The basic flow of the conventional process is as follows: the retailers' packages are gathered at a central United States Postal Service (“USPS”) or another delivery service office (e.g., UPS, FedEx) for the district where the packages originate. This district office then disperses the packages to other USPS offices and centers until each package reaches the corresponding district where the consumer resides, and then the final step in the delivery process occurs. One of problems with such a distribution system is that the collection and the subsequent divergement of the packages involves a large number of steps.

The USPS has been an integral part of this distribution system. The USPS had to constantly increase its capacity with the population growth by creating more mail delivery routes. Until recently this approach has been very productive since the volume of mail has been increasing as the population grew. Currently, the volume of the mail has been decreasing, partly due to the advent of e-mail, while the population has sustained its growth. Thus, the carriers of the USPS are faced with more stops on their routes, but carry less mail to those locations. This results in an inefficient use of the time of the carriers of the USPS and, hence, wasted resources.

Businesses that tried to deliver their goods to consumers in more efficient ways attempted to get around the multiple and lengthy steps of the delivery services. One of the proposed solutions was for the business to deliver its packages solely within its local district by using messengers, which is an example of an asynchronous delivery method. An asynchronous delivery method has no predefined routes; each time a consumer would make a purchase, a messenger would be dispatched to the location designated by the consumer. While this model is independent of a multitude of sorting and shipment facilities utilized in the conventional delivery networks, it is also inefficient. It requires a large number of messengers that make deliveries to random locations; thus, it is impossible to set up organized and streamlined delivery routes.

### SUMMARY OF THE INVENTION

Described is a method and system for a business-to-consumer delivery network within a local district. A package is prepared for a delivery to a recipient. A label is placed on a package. The label includes data regarding a sender, a recipient and a package identification. The sender and recipient are located within a predetermined local geographical area. The package is provided to a messenger of a delivery service during a routine stop of the messenger.

Then, the package is delivered to a local delivering center of the delivery service which services the predetermined geographical area. Subsequently, the package is registered and sorted using the label only at the delivering center. Finally, the package is delivered to the recipient by a further messenger of the delivery service during a routine stop of the further messenger.

### BRIEF DESCRIPTION OF THE DRAWINGS

The accompanying drawings are included to provide a further understanding of the invention and are incorporated in and constitute part of the specification, illustrate several embodiments of the invention and, together with the description, serve to explain examples of the present invention. In the drawings:

FIG. 1 is a diagram of a single USPS district which contains local consumers and a local business;

FIG. 2 is a flow chart illustrating an exemplary embodiment of a method according to the present invention; and

FIG. 3 is a flow chart illustrating further detail of the method according to the present invention shown in FIG. 2.

### DETAILED DESCRIPTION

The present invention is directed at a system and method for utilizing an existing infrastructure (e.g., delivery routes, facilities, carriers, devices, scanners, etc.) of the USPS in order to create a more efficient and convenient business-to-consumer delivery network.

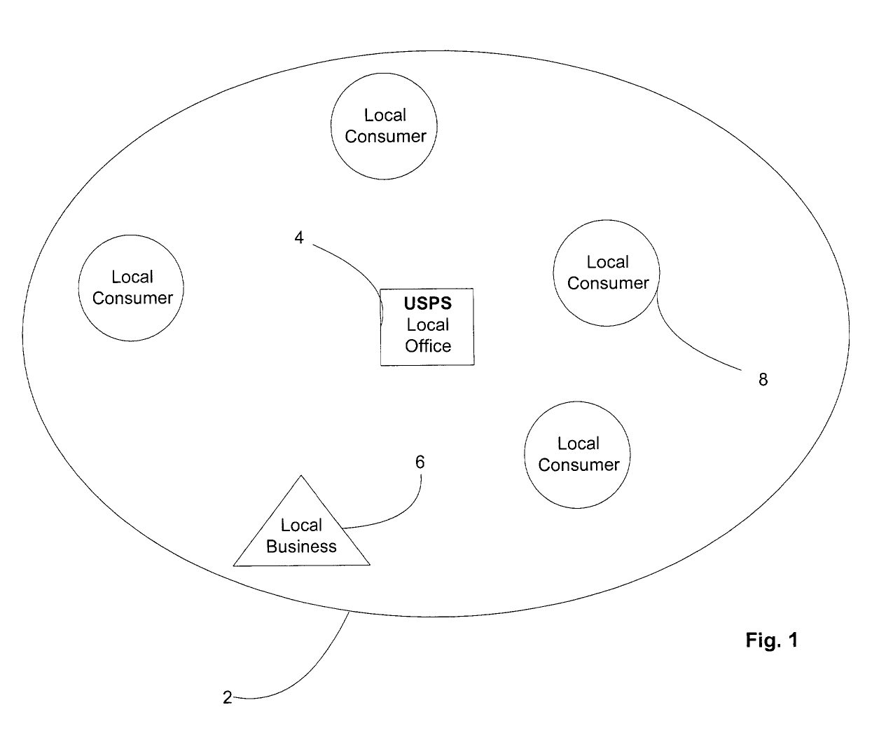

FIG. 1 shows a local postal district 2 which includes a USPS local office 4, local consumers 8 and a local business 6. The local USPS office 4 serves as a hub for delivering mail within the district 2 (e.g., a particular zip code). The business 6 may be any business that deals with the consumers 8 within the district 2. For example, the business 6 may be a branch location of a national chain of rental/retail stores, (e.g., Blockbuster, Hollywood Video, etc.) or a local small business (e.g, a music store, a travel agency, etc.). The consumer 8 may include any individual or entity that may utilize (e.g. purchases/rents) goods and/or services from the business 6. For example, the consumer 8 may be a residential customer or another local business. The business 6 and the consumers 8 are regularly visited (e.g., at least once a day) by a carrier of the USPS on his route to/from the USPS office 4 to drop off and/or pick up mail.

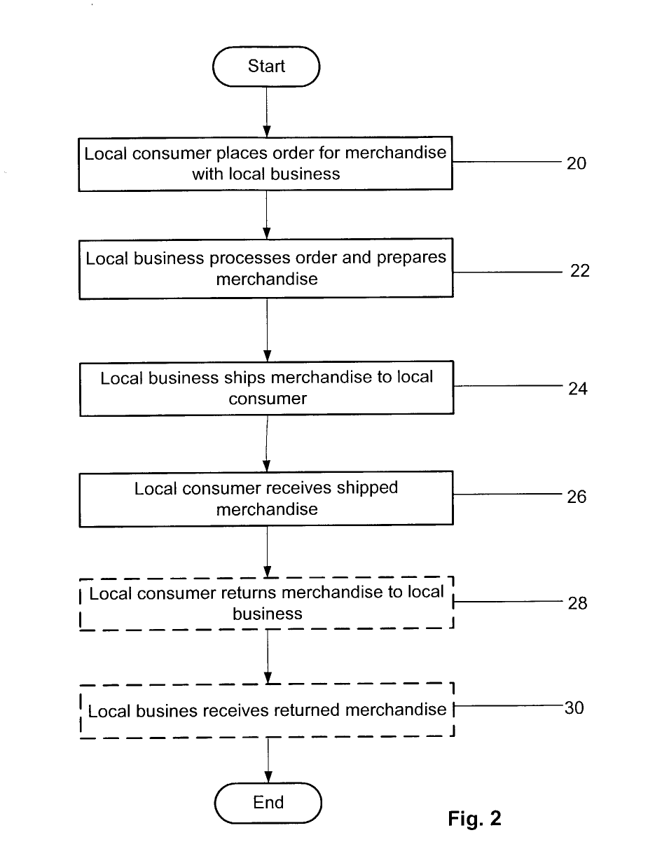

FIG. 2 shows an exemplary embodiment of a method according to the present invention. In step 20, the consumer 8 places an order for merchandise with the business 6. The order may be placed remotely (e.g., utilizing a fax machine, an e-mail, a web site, a phone, etc.) or the consumer 8 may place the order at the location of the business 6 by using a written order (e.g., an order form, a postcard, etc.).

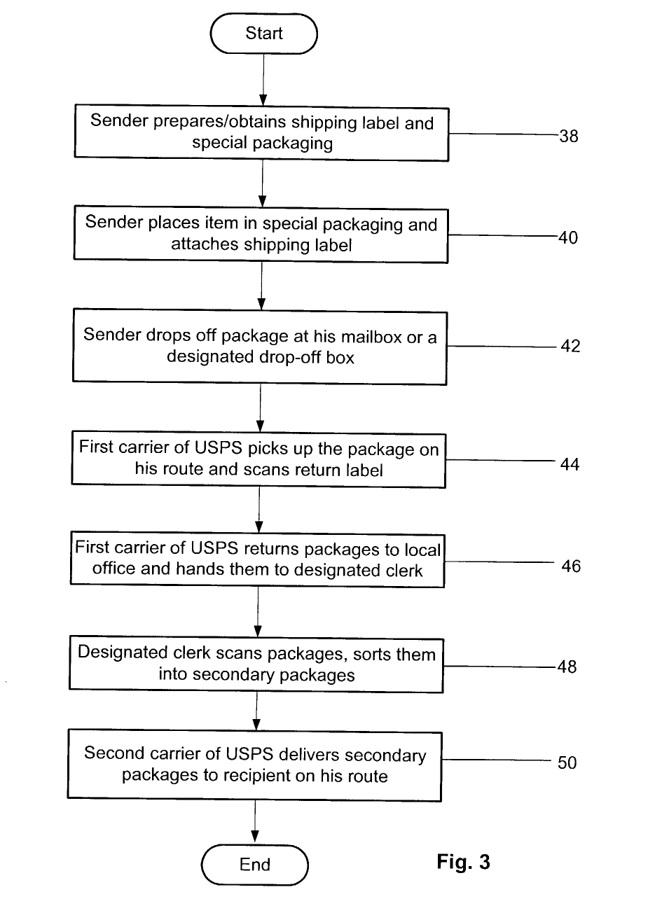

In step 22, upon receiving the order from the consumer 8, the business 6 process es the order. The order processing may include, for example, entering of the order into a particular database, searching through the inventory, etc. ordering the merchandise if the business 6 does not have the merchandise in the inventory. Once the merchandise is located, the business 6 prepares it for shipment (e.g., by packaging the goods, placing proper mailing labels, etc.). A detailed description of the preparation method for shipment is shown in FIG. 3 and is described below.

In step 24, the business 6 ships the merchandise to the consumer 8 via the USPS. In particular, the business 6 places the properly packaged and labeled merchandise in a drop-off location where a first carrier of the USPS picks it up and delivers it to the local USPS office 4. The package is processed and sorted at the local USPS office 4 and then, it is assigned to a second carrier of the USPS who delivers the package to the consumer 8. A detailed description of the shipping method is shown in FIG. 3 and is described below.

In step 26, the consumer 8 receives the package. The package may be either placed in the mailbox of the consumer 8 or a special designated drop-off/pick-up box. In addition, the consumer 8 may be required sign for the package. At this point, the transaction between the consumer 8 and the business 6 may be completed.

Steps 28 and 30 are optional, since they are contingent on the desire or the need of the consumer 8 to return the merchandise to the business 6. For example, the consumer 8 may wish to return the merchandise for a variety of reasons (e.g., dissatisfaction with the merchandise, the merchandise is damaged, the merchandise was rented and has to be returned). In that case, the consumer 8 may have to purchase special packaging and prepare a shipping label that is used to ship the goods back to the business 6. Alternatively, the packaging and/or labeling may be prepared and/or prepaid by the business 6. This step is similar to the procedure followed by the business 6 in step 22.

In step 30, the business 6 receives the returned merchandise shipment from the consumer 8. The process is substantially similar to the one described in step 26. In order to complete the transaction, all the balances may have to be paid (e.g., the consumer 8 may have to pay for a restocking fee). Alternatively, the business 6 may repair the merchandise or provide a replacement to the consumer 8, thus, the process restarts at step 24.

FIG. 3 further describes the steps of the processes discussed above. In step 38, the sender (who may be the consumer 8 or the business 6) prepares the special packaging and the shipping label. The special packaging and the shipping label may be obtained from the USPS office 4 or generated by the sender. For example, the sender may prepare the label by utilizing the website of the business 6 or the USPS office 4. During that process, the sender may enter the required information (e.g., sender's address, recipient's address, etc.), while the website would automatically input the corresponding information pertinent to the recipient (e.g., route number, the serial number of the business 6, etc.). The label may contain the serial number of the business 8 and the carrier of the USPS route number on which the recipient is located. Such information may be necessary to facilitate the transition of the packages within the district 2. The label may also contain a bar code so that input and storage of the information regarding the package may be accomplished while the package is in transit.

The payment for the shipment may be included in the price of the special packaging or the shipping label. For example, the sender would pay for shipment during purchase of the special packaging or the generation of the shipping label. Alternatively, either the sender or the recipient, or both may maintain a deposit account with the USPS office 4 so that all shipments are automatically charged to that account. In step 40, the local sender prepares the package for shipment by placing it in a special package and attaching the shipping label.

In step 42, the sender drops off the package at its own mailbox or a designated drop-off box. The drop-off box may be implemented in order to facilitate the especially congested routes. The drop-off boxes may be located within a commercial or a business center and may have multiple designated pick-up times. Alternatively, the first carrier may pick-up the package directly from the sender.

In step 44, the first carrier picks up the packages from the mail boxes or the specially designated drop-off box. During this step, the first carrier may use a device, (e.g., a Model Data Collection Device “MDCD”) to scan the bar codes located on the shipping labels of the packages. Substantially similar devices are already in use by the USPS employees and used during the processing of express and priority mail. The scanning allows the sender and/or the recipient to track movement of their shipments and inventories.

In step 46, the first carrier returns the packages that were collected on the route to the USPS office 4 and transfers them to a designated clerk of the USPS office 4. The designated clerk, in step 48, processes the packages received. In particular, the clerk may scan the shipping labels on the packages using, e.g., the MDCD, and updates the computer database. The clerk then sorts the packages for the second carrier according the route number indicated on the shipping label. In addition, if the shipping price has not been paid prior to step 46 (e.g., during the purchase of the special packaging or the generation of the shipping label), the shipment price may be withdrawn from the deposit account established at the USPS office 4 by the sender or the recipient depending on the shipping arrangement.

In step 50, the second carrier delivers the packages processed by the clerk at the USPS office to the recipient. The second carrier may be the first carrier (who originally picked up the packages in step 44), if the recipient of the package is located on the same route as the sender.

As described above, the USPS is faced with a constantly expanding amount of routes yet a decrease in the volume of the mail. In addition, the local businesses have not been able to efficiently reach local consumers using conventional delivery systems. One of the advantages of the present invention is that it provides the USPS with another source of income while utilizing its resources in a more efficient manner. In addition, the present invention provides the business 6 with an easier way to deliver goods to the consumers 8 by circumventing the lengthy conventional centralized delivery systems or expensive and inefficient messengers. The deliveries and pick-ups are contained solely within the district 2 and eliminate the involvement of other facilities, hence, drastically reducing the steps that are associated with the conventional mail delivery system. The consumers 8 may either choose to order goods from the comfort of their home and simply pick it up after the next delivery or they may choose to purchase the goods from the store and later return them through the system of the present invention.

One of the many embodiments of the present invention is directed toward a business that relies on constant rotation of goods within the district 2 (e.g., a video or DVD renting service, such as Blockbuster, Hollywood Video, etc.). The consumer 8 may rent video games, DVD'S, video's, and other products by directly picking up the goods from the store. Another option for the consumer 8 is to place orders remotely (e.g., phone, internet, etc.). Upon receiving the order, the rental service prepares the merchandise for shipment and ships it according to the present invention. The consumer 8 receives the rental shipment in his mailbox within a short period of time i.e., (e.g., 24 hours). The present invention may operate on a 24-hour cycle because that is the shortest period of time between two consecutive USPS deliveries to any one location. In particular, the cycle denotes the first carrier picking up the package and the second carrier delivering it. Once the consumer 8 is ready to return the rental he places it in the primary packaging with a label as described in step 42. Once the first carrier delivers the rental packages to the USPS office 4, the designated clerk sorts the rental packages by route number and the second carrier delivers the packages to the rental store the next day.

Another embodiment of the present invention may be applied in the pharmaceutical industry, and, in particular, the retail distribution of prescription drugs to patients. The order or the prescription may be delivered remotely (e.g., fax, e-mail, etc.) to the pharmacy either by the consumer 8 or his doctor. The pharmacy, upon receiving the order and preparing the medication, places the goods in the special packaging as described in step 44. The consumer 8 receives the medication, usually within a 24-hour period. In some instances, the consumer 8 may wish to return the merchandise if the pharmacy made a mistake. In that instance, he may place the goods in the special package and prepare to send it back to the pharmacy.

It will be apparent to those skilled in the art that various modifications and variations can be made in the structure and the methodology of the present invention, without departing from the spirit or scope of the invention. Thus, it is intended that the present invention cover the modifications and variations of this invention provided they come within the scope of the appended claims and their equivalents.

What is claimed is:

1. A method, comprising the steps of:
(a) placing a label on a package, the label including data regarding a sender, a recipient and a package identification, the sender and recipient being located within a predetermined local geographical area;
(b) providing the package to a messenger of a delivery service during a routine stop of the messenger;
(c) delivering the package to a local delivering center of the delivery service which services the predetermined geographical area;
(d) registering and sorting the package using the label only at the delivering center; and
(e) delivering the package to the recipient by a further messenger of the delivery service during a routine stop of the further messenger.

2. The method according to claim 1, wherein the predetermined local geographical area include an area within a single postal zip code.

3. The method according to claim 1, further comprising the steps of:
receiving an order for merchandise from the recipient;
processing the order by the sender;
generating the label by the sender; and
placing the merchandise into the package.

4. The method according to claim 3, wherein step (a) is performed via at least one of a facsimile, a phone, an email, the Internet, and mail.

5. The method according to claim 1, wherein the data is stored on the label in a form of a bar code.

6. The method according to claim 5, wherein step (d) is performed by scanning the label using a bar code scanner, the method further comprising the step of:
providing the data to a computer database.

7. The method according to claim 1, wherein the further messenger is the messenger when the recipient and sender are situated on the same route.

8. The method according to claim 1, further comprising the step of:
providing a return label to the recipient, the return label being addressed to the sender and including further data which is substantially similar to the data of the label.

9. The method according to claim 8, further comprising the step of:
returning the package from the recipient to the sender using steps substantially similar to steps (a) -- (e).

10. The method according to claim 6, further comprising the steps of:
before step (c), scanning data of the label by the messenger; and
providing the data to the database.

11. The method according to claim 10 further comprising the steps of:
after step (e), scanning data of the label by the further messenger; and
providing the data to the database.

12. The method according to claim 11, further comprising the step of:
tracking a movement of the package using the database.

13. The method according to claim 11, wherein the scanning steps are performed using the bar code scanner.

14. The method according to claim 1, wherein the sender is an individual who used audio/visual material, the recipient being a business that rented the material to the sender.

15. A method, comprising the steps of:
(a)receiving the package by a messenger of a delivery service during a routine stop of the messenger, the package having a label which includes data regarding a sender, a recipient and a package identification, the sender and recipient being located within a predetermined local geographical area;
(b) delivering the package to a local delivering center of the delivery service which services the predetermined geographical area;
(c) registering and sorting the package using the label only at the delivering center; and
(d) delivering the package to the recipient by a further messenger of the delivery service during a routine stop of the further messenger.
